(19) United States
(12) Patent Application Publication
(10) Pub. No.: US 2011/0300405 A1
(43) Pub. Date: Dec. 8, 2011

(54) OXIDATION RESISTANT COMPONENTS AND RELATED METHODS

(75) Inventors: George Albert Goller, Greenville, SC (US); Dennis William Cavanaugh, Simpsonville, SC (US)

(73) Assignee: GENERAL ELECTRIC COMPANY, Schenectady, NY (US)

(21) Appl. No.: 12/793,411

(22) Filed: Jun. 3, 2010

(51) Int. Cl. B32B 15/01; B05D 3/02

(52) U.S. Cl. 428/650; 427/383.7

(57) ABSTRACT

Oxidation resistant components and methods for creating an aluminum diffusion surface layer within substantially nickel- and cobalt-free components are disclosed. An aluminum-containing slurry may be applied to a component. The component may then be heated to diffuse aluminum into the component and to form an aluminum diffusion surface layer therein. The surface layer may be characterized by an intermetallic aluminum-containing phase extending below the surface of the component.

### FIELD OF THE INVENTION

The present subject matter relates generally to oxidation resistance for high temperature metal components and particularly to oxidation resistant metal components and methods of creating aluminum diffusion surface layers within metal components.

### BACKGROUND OF THE INVENTION

The operating environment within a gas turbine engine is both thermally and chemically hostile. For example, operating temperatures within a turbine engine may range from about 1200° F. to about 2200° F. (about 650° C. to about 1200° C.), depending on the type of gas turbine being used. Such high temperatures combined with the oxidizing environment of a gas turbine generally necessitates the use of a nickel- or cobalt-containing specialty alloy having a high oxidation resistance and, thereby, an acceptable operating life within the turbine. Accordingly, gas turbine components are typically formed from nickel alloy steels, nickel-based or cobalt-based superalloys, or other specialty alloys.

Significant advances in the high temperature capabilities of such specialty alloys have been achieved through the use of oxidation resistant environmental coatings capable of protecting the alloys from oxidation, hot corrosion, etc. For example, aluminum-containing coatings, particularly aluminide coatings, have been used as environmental coatings on nickel- or cobalt-based superalloy gas turbine engine components. During high temperature exposure in air, the aluminide coating forms a protective aluminum oxide (alumina) scale that inhibits oxidation of the coating and the underlying substrate.

Diffusion coatings on superalloy substrates are typically characterized as having an outer coating or additive layer that primarily overlies the original surface of the coated substrate and a diffusion zone created below the original surface. The outer coating of the diffusion coating primarily contains the intermetallic phase MAl, wherein M is typically nickel or cobalt. For example, in a nickel-based superalloy, the outer coating consisting primarily of NiAl which is formed as aluminum diffuses into the metal and combines with nickel diffusing outward from the metal substrate. The diffusion zone of the diffusion coating is generally characterized by a hard, brittle intermetallic phase that forms during the coating reaction as a result of gradients and changes in elemental solubility. Thus, in a nickel-based superalloy, the diffusion zone is created due to the inward diffusion of the aluminum and the outward diffusion of nickel, with the concentration of aluminum gradually decreasing with increasing distance from the outer coating and the concentration of nickel gradually increasing with increasing distance from the outer coating.

Aluminide diffusion coatings are typically formed by a diffusion process, such as pack cementation or vapor phase aluminizing (VPA) techniques, or by diffusing aluminum deposited by chemical vapor deposition (CVD) or slurry coating. For example, in a slurry coating diffusion process, an aluminum-containing slurry is prepared and applied to the surface of the superalloy substrate to be coated. The slurry is then heated to a high temperature, such as above 1400° F. (about 760° C.) and maintained at such temperature for a duration sufficient to permit the aluminum to diffuse within the superalloy. Generally, the processing temperature will determine whether the diffusion coating is characterized as an outward-type or inward-type, with outward-type diffusion occurring at higher processing temperatures (e.g. at or near the solution temperature of the alloy being coated). In the case of a nickel-based superalloy, an outward-type diffusion promotes the outward diffusion of nickel from the base metal into the deposited aluminum layer (e.g. the aluminum-containing slurry coating) to form the outer coating and also reduces the inward diffusion of aluminum from the deposited aluminum layer, resulting in a relative thick outer coating above the original surface of the substrate. Conversely, lower processing temperatures promote the inward diffusion of aluminum from the deposited aluminum layer into the substrate, yielding an inward-type diffusion coating characterized by an outer coating that may extend below the surface of the substrate.

Although it is well understood that aluminum diffused specialty alloys provide excellent oxidation resistance, there is at least one downside to their use as the base metal in high temperature components. In particular, specialty alloys can be very expensive to produce, with material costs alone being significantly higher than lower grade/alloy steels. Moreover, these increased material costs are in addition to the costs typically associated with treating/processing the specialty alloys in order to provide them with any necessary coatings. Thus, from start to finish, the cost of producing a high temperature, specialty alloy component can be quite substantial.

Efforts have been made to replace the use of specialty alloys in high temperature components through the development of oxidation resistant, lower grade/alloy steels. For example, attempts have focused on creating high aluminum alloys through alloy additions in many low cost steels. However, achieving a high aluminum alloy during melting of such lower grade/alloy steels has proved difficult and problematic.

Accordingly, a relatively low cost steel that exhibits similar oxidation resistance to aluminide coated specialty alloys, such as nickel- and cobalt-based superalloys, would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, a method is generally disclosed for creating an aluminum diffusion surface layer within a substantially nickel- and cobalt-free component. The method may include applying a slurry coating to a surface of the component and heating the component to diffuse aluminum from the slurry coating into the component so as to form an aluminum diffusion surface layer within the component.

In another aspect, an oxidation resistant component is generally disclosed. The oxidation resistant component may include a base metal configured as a component, wherein the base metal is substantially free from both nickel and cobalt and comprises up to about 27% chromium by weight. Additionally the oxidation resistant component includes an aluminum diffusion surface layer extending below a surface of the base metal. The aluminum diffusion surface layer is characterized by an intermetallic aluminum-containing phase having a thickness of greater than about 50 micrometers.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended figures, in which:

FIG. 1 is a micrograph showing an aluminum diffusion surface layer within a Cr—Mo—V—Nb—B alloy steel (9% Cr) in accordance with an embodiment of the present subject matter;

FIG. 2 is a micrograph showing an aluminum diffusion surface layer within a cast 410 stainless steel (12% Cr) in accordance with an embodiment of the present subject matter; and

FIG. 3 is a micrograph of a diffusion coating within a nickel-containing 347 stainless steel (21% Cr12% Ni), particularly showing both the outer coating and diffusion zone of the diffusion coating.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter is generally directed to an oxidation resistant metal component and a method of creating an aluminum diffusion surface layer within a metal component. In particular, a low cost, oxidation resistant metal component is disclosed that is suitable for use in various high temperature, oxidizing environments, such as the environment of a gas turbine. In one embodiment, the oxidation resistant component may comprise a turbine component formed from a lower grade/alloy steel that is significantly less expensive than the specialty alloys, such as nickel- or cobalt-based superalloys, typically used to form turbine components. Additionally, the present subject matter discloses a method for creating an oxidation resistant, aluminum-rich diffusion layer in the metal component. The method generally includes applying an aluminum-containing slurry to the surface of the component and heating the component to permit the aluminum within the slurry to diffuse into the metal component.

The inventors of the present subject matter have discovered that an oxidation resistance similar to that seen in an aluminum diffusion coated superalloy may also be exhibited in lower grade/alloy steels treated with an aluminum diffusion process. For example, it has been found that aluminum may be diffused into various low cost steels, such as steels being substantially free from both nickel and cobalt, to form an aluminum diffusion surface layer that prevents the oxidation of such steels during exposure to high temperature oxidants. In particular, oxidation testing has confirmed that an aluminum diffusion surface layer may be created in lower grade/alloy steels that is highly oxidation resistant at elevated temperatures for extended periods of time, as the aluminum within the diffusion layer forms a protective aluminide oxide (alumina) scale that inhibits oxidation of the steel. Thus, for example, an aluminum diffusion surface layer may be formed in a 10Cr alloy steel (i.e. an alloy with a chromium content of about 8% to about 11%, by weight). Testing has indicated that forming such a surface layer within the 10Cr alloy steel enables the steel to withstand an oxidizing environment at temperatures of about 1800° F. with no signs of oxidation. Typically, a 10Cr alloy steel would rapidly oxidize at temperatures above approximately 1000° F.

Additionally, the inventors of the present subject matter have discovered that, by applying an aluminum diffusion process to a metal component being substantially free from nickel and cobalt, a single aluminum diffusion surface layer may be formed within the base metal of the component (i.e. below the original surface of the base metal). Thus, it has been found that aluminum diffusion of such components does not result in an outer coating overlying the original surface of the base metal, but rather a diffused surface layer characterized by a strong intermetallic aluminum-containing phase that is metallurgically part of the base metal. Moreover, this inwardly diffused, surface layer may be formed across a wide range of temperatures (such as from about 1500° F. to about 2100° F.), resulting in the ability to create surface layers within the base metal of varying uniform thicknesses depending on the particular diffusion temperature. Further, its has been found that the aluminum diffusion surface layer created within these lower grade/alloy steels is relatively ductile, thereby reducing the likelihood of chipping, scratching and/or cracking at the surface of the steel.

Generally, the present subject matter will be described herein with reference to turbine components for use within a gas turbine. However, it should be appreciated that application of the present subject matter need not be limited to gas turbine components, but may be generally applied to any high temperature components. Particularly, the present subject matter may be utilized to form an oxidation resistant, relatively low cost component for use in various high temperature industrial applications.

With regard to gas turbine applications, the present subject matter provides that various low grade/alloy steels may be used to form a turbine component, which may then be subjected to a diffusion process to create a highly oxidation resistant, aluminum diffusion surface layer within the component. As such, the high costs associated with the use of specialty alloys may be avoided. Generally, utilizing the relatively low grade/alloy steels comtemplated by the present subject matter, turbine components may be formed that are oxidation resistant at operating temperatures of up to about 1800° F. Thus, the present subject matter may be applicable to turbine components used in the various sections of a gas turbine, depending primarily on the operating temperatures of the gas turbine utilized. For example, in various embodiments, the low cost steels disclosed herein may be used to form oxidation resistant turbine components that may include, but are not limited to, turbine shrouds, compressor vanes and blades, as well as many turbine buckets and nozzles.

Moreover, the diffusion process of the present subject matter may be used to form an aluminum diffusion surface layer in both cast and wrought turbine components. For instance, various turbine components may be formed by a casting process. In treating such components, it has been found that the slurry coating process disclosed herein can be applied directly to the as-cast surface of the component. Thus, prior machining is not required to form a protective aluminum surface layer within the cast component. Similarly, the slurry coating process can be applied directly to the surface of a wrought turbine component to form a protective aluminum surface layer within the wrought component.

In one embodiment, the base metal used to form the low cost, oxidation resistant turbine component of the present subject matter may generally comprise any base steel being substantially free from both nickel and cobalt and including a chromium content, by weight, of up to 27%. It should be appreciated that, by substantially free from both nickel and cobalt, it is meant that the base metal generally includes an insignificant amount of nickel or cobalt, such as less than about 0.75%, by weight, of either nickel or cobalt. Thus, the base metal may comprise various relatively low cost, low grade/alloy steels. For example, in several embodiments, the base metal forming the turbine component may include, but is not limited to, a ferritic stainless steel having a chromium content, by weight, ranging from about 11% to about 27%, a martensitic stainless steel having a chromium content, by weight, ranging from about 11% to about 18%, a 10Cr alloy steel having a chromium content, by weight, ranging from about 8% to about 11%, an alloy steel having a chromium content, by weight, ranging from about 1% to about 8%, or a carbon steel having a carbon content, by weight, of about 0.01% to about 1.0% and containing little to no chromium.

It should be appreciated that the composition of the intermetallic aluminum-containing phase of the aluminum diffusion surface layer may generally vary depending on the composition of the base metal to which an aluminum diffusion process is applied. For example, in steels containing chromium, the aluminum diffusion surface layer may include a single, intermetallic iron-chromium-aluminum phase. Additionally, in steels containing little to no chromium, such as in many carbon steels, the surface layer may be generally characterized by an intermetallic iron-aluminum phase.

According to one embodiment, the aluminum diffusion surface layer may be formed within the base metal of the turbine component by a slurry coating diffusion process in which aluminum is deposited and diffused into the surface of the formed turbine component. The slurry coating process makes use of an aluminum-containing slurry, the composition of which includes a donor material containing a metallic aluminum, a halide activator, and a binder. Notably missing from the ingredients of the slurry composition are inert fillers, such as inert oxide materials (e.g. aluminum oxide) whose particles are prone to sintering during the diffusion process. Additionally, although the present subject matter generally describes a slurry coating diffusion process, it is foreseeable that the aluminum diffusion surface layer may be formed within a substantially nickel- and cobalt-free turbine component by various other known diffusion processes, such as pack cementation, VPA and CVD processes.

Suitable donor materials for the slurry coating composition may generally include aluminum alloys with higher melting temperatures than aluminum, which has a melting point of approximately 1220° F. (660° C.). For example, donor materials may include, but are not limited to, metallic aluminum alloyed with chromium, cobalt and/or iron. Other suitable alloying agents having a sufficiently high melting point so as to not deposit during the diffusion process, but instead serve as an inert carrier for the aluminum of the donor material, should be apparent to those of ordinary skill in the art. In a preferred embodiment, the donor material comprises a chromium-aluminum alloy. Particularly, it has been found that the alloy 56Cr-44Al (44%, by weight, aluminum, with the balance chromium and incidental impurities) is well-suited for diffusion processes performed over the wide range of diffusion temperatures contemplated by the present subject matter.

In one embodiment, the donor material may be in the form of a fine powder to reduce the likelihood that the donor material becomes lodged or entrapped in crevices, internal passages or the like of the turbine component. For example, in particular embodiments, the particle size for the donor material may be −200 mesh (a maximum diameter of not larger than 74 micrometers) or finer. However, it should be appreciated that powders with a larger mesh size may be used within the scope of the present subject matter. For instance, it is foreseeable that powders with a mesh size of 100 mesh (a maximum diameter of up to 149 micrometers) or larger may be used.

Various halide activators may be used within the slurry coating composition. Particularly suitable halide activators may include ammonium halides, such as ammonium chloride (NH₄Cl), ammonium fluoride (NH₄F), ammonium bromide (NH₄Br) and mixtures thereof. It should be appreciated, however, that other halide activators may be used within the scope of the present subject matter. Generally, suitable halide activators are capable of reacting with the aluminum contained in the donor material to form a volatile aluminum halide (e.g. AlCl₃, AlF₃) that reacts at the surface of the turbine component and is diffused into the component to from the intermetallic aluminum-containing phase. Additionally, for use in the slurry, the halide activator may be in the form of a fine powder. Further, in some embodiments, the halide activator powder may be encapsulated to inhibit the absorption of moisture, such as when a water-based binder is utilized.

Suitable binders contained in the slurry coating composition may generally include an organic polymer. For example, in one embodiment, the binder may include various alcohol-based organic polymers, water-based organic polymers or mixtures thereof. As such, the binder may be capable of being burned off entirely and cleanly at temperatures below that required to vaporize and react the halide activator, with the remaining residue being essentially in the form of an ash that can be easily removed, for example, by forcing a gas, such as air, over the surface of the component following the diffusion process. Commercial examples of suitable water-based organic polymeric binders include a polymeric gel available under the name BRAZ-BINDER GEL from the VITTA CORPORATION (Bethel, Conn.). Suitable alcohol-based binders can be low molecular weight polyalcohols (polyols), such as polyvinyl alcohol (PVA). Additionally, in one embodiment, the binder may also incorporate a cure catalyst or accelerant such as sodium hypophosphite. It should be appreciated that various other alcohol- or water-based binders may be used within the scope of the present subject matter. Moreover, it is foreseeable that inorganic polymeric binders may also be suitable for use within the scope of the present subject matter.

Suitable slurry compositions generally have a solids loading (donor material and activator) of about 10% to about 80%, by weight, with the balance binder. More particularly, suitable slurry compositions may contain, by weight, donor material powder in the range of about 35% to about 65%, such as from about 45% to about 60% and all other subranges therebetween, binder in the range of about 25% to about 60%, such as from about 25% to about 50% and all other subranges therebetween, and halide activator in the range from about 1% to about 25%, such as from about 5% to about 25% and all other subranges therebetween. Within such ranges, the slurry composition may have a consistency that allows its application to a turbine component by a variety of methods, including spraying, dipping, brushing, injection, etc.

Additionally, it has been found that the slurry compositions of the present subject matter can be applied to have a non-uniform green state thickness (i.e. an un-dried thickness) and still produce an intermetallic aluminum-containing phase of very uniform thickness. Further, it has been found that the disclosed slurry compositions may be capable of producing an inwardly diffused, aluminum-rich surface layer over a broad range of diffusion temperatures, generally in a range of about 1500° F. to about 2100° F. (about 815° C. to about 1150° C.), such as from about 1800° F. to about 2000° F. (about 980° C. to about 1090° C.) and all other subranges therebetween.

After applying the slurry to the surface of a formed component, such as a wrought or cast turbine component, the component may be immediately placed in a coating chamber or retort to perform the diffusion process. Additional slurry coatings or activator materials are not required to be present in the retort. The retort may then be evacuated and backfilled with an inert or reducing atmosphere (such as with argon or hydrogen). The temperature within the retort may then be raised to a temperature sufficient to burn off the binder, for example from about 300° F. to about 400° F. (about 150° C. to about 200° C.), with further heating being performed to attain the desired diffusion temperature described above, about 1500° F. to about 2100° F., during which time the halide activator is volatilized, an aluminum halide is formed and aluminum is deposited on the surface of the component. The component is then held as such diffusion temperature for a duration of about 2 hours to about 12 hours, such as about 2 hours to about 4 hours, to allow the aluminum to diffuse into the surface of the component.

Following the diffusion process, the component may be removed from the retort chamber and cleaned of any residues remaining in and/or on the component. It has been found that such residues are essentially limited to an ash-like residue of the binder and residue of donor material particles, the latter of which being primarily the metallic constituent (or constituents) of the donor material other than aluminum. These residues may be readily removed, such as with forced gas flow, without resorting to more aggressive removal techniques, such as wire brushing, glass bead or oxide grit burnishing, high pressure water jet, or other such methods that entail physical contact with a solid or liquid to remove firmly attached residues.

As indicated above, the slurry coating diffusion process may be used to form a diffusion surface layer, characterized by an intermetallic aluminum-containing phase, within a substantially nickel- and cobalt-free turbine component. The thickness of such surface layer may vary depending primarily on the diffusion temperature, as well as the duration of the diffusion treatment. However, the thickness of the aluminum diffusion surface layer may range, as measured from the surface of the component to the location within the base metal at which the aluminum concentration is 0%, from about 25 micrometers to about 400 micrometers, such as about 100 micrometers to about 400 micrometers or, about 225 micrometers to about 350 micrometers, and all other subranges therebetween. Without wishing to be bound by any particular theory, it is believed that such relatively deep surface layers, particularly thicknesses greater than about 200 micrometers, may be achieved due to the particular aluminum diffusion process utilized as well as the absence of nickel and cobalt within the base metal.

Additionally, the aluminum content of the surface diffusion layer may also vary depending on, but not limited to, the diffusion temperature and the duration of the treatment. Generally, it has been found that the aluminum content at the surface of the turbine component may range from about 10% to about 14%, by weight, such as from about 12% to about 14% and all other subranges therebetween, with the aluminum content reducing to 0% at the interface between the aluminum diffusion surface layer and the non-diffused base metal. Thus, the surface layer may be a graded layer having a diminishing aluminum concentration from the surface of the component into its thickness. Moreover, it is foreseeable that the aluminum content at the surface of the turbine component may be greater than 14%, by weight, given differing diffusion temperatures and durations as well as differing percentages of aluminum content within the slurry composition.

Moreover, it has also been found that the aluminum diffusion surface layer formed in the lower grade/lower alloy steels is relatively ductile and malleable. Generally, the hardness of the surface layer may be within the Rockwell B scale. In particular, hardness values of the surface layer may range in the mid to upper Rockwell B scale, such as from about 70 HRB to about 95 HRB or from about 75 HRB to about 90 HRB and all other subranges therebetween. As such, turbine components formed from the steels contemplated by the present subject matter and subjected to the described slurry coating diffusion process may be less likely to be chipped, scratched or cracked during installation or operation. It should be noted that all hardness values referenced herein were taken using a Knoop hardness test and converted to the Rockwell B scale. Specifically, a pyramidal diamond was pressed into a cross-sectioned surface of the material of interest and the resulting indentation was measured using a microscope.

Additionally, the hardness of the surface layer, as well as other mechanical and oxidation resistant characteristics of the surface layer, remains unaffected by heat treatment of the non-diffused base metal. Thus, it should be appreciated that, after the aluminum diffusion process, the base metal of a turbine component may be heat treated to obtain any desired mechanical properties. For example, it was found that a component may be annealed or quenched and tempered without altering the properties of the aluminum diffusion surface layer. Further, it should be appreciated that, if desirable, the turbine component may also be subjected to a pre-oxidation treatment, such as by exposing the component to an oxidant in a controlled atmosphere to form a protective alumina scale on its surface.

The examples which follow are merely illustrative, and should not be construed to be any type of limitation on the scope of the claimed invention

### Example 1

A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

Ten test pieces were also prepared from a forged Cr—Mo—V—Nb—B alloy steel (9.0-9.6% Cr, 1.50-1.70% Mo, 0.25-0.30% V, 0.045-0.065% Nb, 0.008-0.012% B). The test pieces each had an approximate size of 25.4×25.4×12.7 mm (1×1×0.5 inches). A slurry coating of non-uniform thickness was applied directly to the surface of each of the test pieces. The coating was applied by pouring the slurry mixture over the test pieces and spreading the mixture around the entire surface of each test piece.

The test pieces were placed in a retort, which was then purged with argon until a −40° F. dew point was achieved. The temperature within the retort was then heated to the diffusion temperature indicated in Table 1 (i.e., 1600° F., 1800° F. or 2000° F.) and held at such temperature for the duration indicated in Table 1 (i.e., 2 hours, 3 hours, 4 hours or 12 hours). The argon gas flow was maintained during heating. The retort was then cooled under argon gas and the test pieces were removed from the retort and sectioned to permit the thickness of their aluminum diffusion surface layers to be measured. The results of such measurements are summarized in Table 1.

TABLE 1
Surface Layer Thickness at Diffusion Temperature/Duration

| | Diffusion | | |
|---|---|---|---|
| | Temperature | Duration | Surface Layer Thickness |
| Test Piece | (° F.) | (hours) | (micrometers (inches)) |
| # 1 | 1600 | 2 | 25 (0.001) |
| # 2 | 1600 | 3 | 51 (0.002) |
| # 3 | 1600 | 4 | 76 (0.003) |
| # 4 | 1800 | 2 | 178 (0.007) |
| # 5 | 1800 | 3 | 254 (0.010) |
| # 6 | 1800 | 4 | 356 (0.014) |
| # 7 | 2000 | 2 | 203 (0.008) |
| # 8 | 2000 | 3 | 330 (0.013) |
| # 9 | 2000 | 4 | 305 (0.012) |
| # 10 | 2000 | 12 | 356 (0.014) |

The thickness of the aluminum diffusion surface layer within each test piece varied depending on both the diffusion temperature and duration of exposure, with thicknesses ranging from 25 micrometers to 356 micrometers. The hardness of the surface layer for each test piece was measured, with the hardness measurements ranging from about 79 HRB to about 85 HRB.

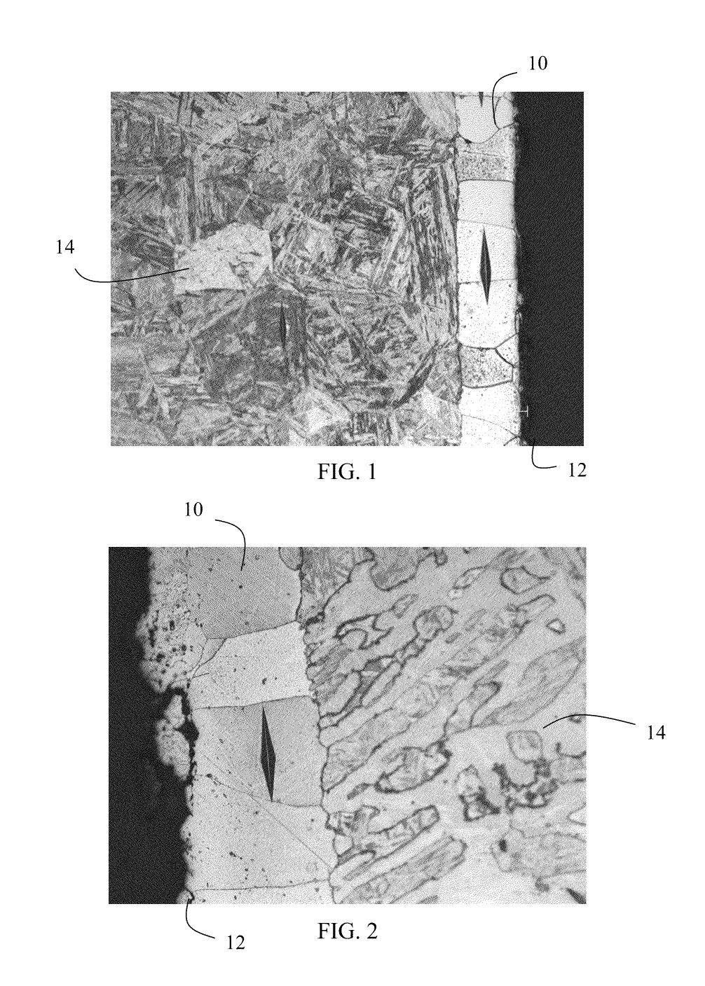

FIG. 1 is a micrograph of test piece # 9 (duration temperature=2000° F. and duration=4 hours) after being quenched and tempered. As can be seen, an aluminum diffusion surface layer 10 was formed in the Cr—Mo—V—Nb—B alloy steel between the original surface 12 of the steel and the non-diffused base metal 14. It was found that the surface layer 10 comprised an intermetallic iron-chromium-aluminum phase, with the aluminum content, by weight, being about 14% at the original surface 12 and reducing to 0% at the interface of the surface layer 10 and the non-diffused base metal 14. Additionally, it was noted that the surface layer 10 exhibited a unique single-wide grain structure. After quench and temper, the hardness of the non-diffused base metal 14 was measured at approximately 50 HRC, while the hardness of the surface layer 10 remained at approximately 80 HRB.

### Example 2

A slurry coating composition was prepared having the following slurry composition, by weight: the percentage of chromium aluminum (56Cr-44Al) indicated in Table 2, 10% ammonium chloride, the balance being VITTA BRAZ-BINDER GEL. The chromium aluminum was in powder form having a particle size of −200 mesh.

Four test pieces were prepared from a forged Cr—Mo—V—Nb—B alloy steel (9.0-9.6% Cr, 1.50-1.70% Mo, 0.25-0.30% V, 0.045-0.065% Nb, 0.008-0.012% B). The test pieces each had an approximate size of 25.4×25.4×12.7 mm (1×1×0.5 inches). A slurry coating of non-uniform thickness was applied directly to the surface of each of the test pieces. The coating was applied by pouring the slurry mixture over the test pieces and spreading the mixture around the entire surface of each test piece.

The test pieces were placed in a retort, which was then purged with argon until a −40° F. dew point was achieved. The temperature within the retort was then heated to a diffusion temperature of 2000° F. and held at such temperature for a duration of 4 hours. The argon gas flow was maintained during heating. The retort was then cooled under argon gas and the test pieces were removed from the retort chamber and sectioned to permit the thickness of their aluminum diffusion surface layers to be measured. The results of such measurements are summarized in Table 2.

TABLE 2
Surface Layer Thickness with Differing Slurry Compositions

| | Chromium Aluminum | Surface Layer Thickness |
|---|---|---|
| Test Piece | Composition | (micrometers (inches)) |
| # 1 | 10% | 221 (0.0087) |
| # 2 | 20% | 218 (0.0086) |
| # 3 | 30% | 244 (0.0096) |
| # 4 | 50% | 305 (0.012) |

The thickness of the aluminum diffusion surface layer within each test piece varied only slightly depending on the percentage of chromium aluminum in the slurry coating, with the largest variation observed with a 50% chromium aluminum composition. The surface layers were characterized by an intermetallic iron-chromium-aluminum phase underlying the original surface of the test pieces. The hardness of the surface layer for each test piece was measured, with average hardness measurements at approximately 80 HRB.

### Example 3

A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

A test piece was prepared from a cast 410 stainless steel (12% Cr). The test piece had an approximate size of 25.4×25.4×12.7 mm (1×1×0.5 inches). A slurry coating of non-uniform thickness was applied directly to the as-cast surface of the test piece. The coating was applied by pouring the slurry mixture over the test piece and spreading the mixture around the entire surface of the test piece.

The test piece was placed in a retort, which was then purged with argon until a −40° F. dew point was achieved. The temperature within the retort was then heated to a diffusion temperature of 2000° F. and held at such temperature for a duration of 4 hours. The argon gas flow was maintained during heating. The retort was then cooled under argon gas and the test piece was removed from the retort chamber and sectioned to permit the thickness of the aluminum diffusion surface layer to be measured.

FIG. 2 is a micrograph of the cast 410 stainless steel test piece following the diffusion treatment. As can be seen, an aluminum diffusion surface layer 10 was formed within test piece between the original surface 12 of the alloy and the non-diffused base metal 14. The surface layer 10 was characterized by an intermetallic iron-chromium-aluminum phase. The thickness of surface layer 10 was approximately 200 micrometers (0.008 inches). Additionally, it was noted that the surface layer 10 exhibited a unique single-wide grain structure. The hardness of the non-diffused base metal 14 was measured at approximately 25 HRC, with the hardness of the surface layer 10 being measured at about 88 HRB to about 90 HRB.

### Example 4

A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

A test piece was prepared from a carbon steel (0.18% C, 1.5% Mn). The test piece had an approximate size of 25.4×25.4×12.7 mm (1×1×0.5 inches). A slurry coating of non-uniform thickness was applied directly to the surface of the test piece. The coating was applied by pouring the slurry mixture over the test piece and spreading the mixture around the entire surface of the test piece.

The test piece was placed in a retort, which was then purged with argon until a −40° F. dew point was achieved. The temperature within the retort was then heated to a diffusion temperature of 2000° F. and held at such temperature for a duration of 2 hours. The argon gas flow was maintained during heating. The retort was then cooled under argon gas and the test piece was removed from the retort chamber and sectioned to permit the thickness of its surface diffusion layer to be measured.

It was found that an aluminum diffusion surface layer was formed within the carbon-steel between the original surface of the alloy and the non-diffused base metal. The surface diffusion layer was characterized by an intermetallic iron-aluminum phase having a thickness of approximately 190 micrometers (0.0075 inches). The hardness of the non-diffused base metal was measured at approximately 90 HRB, with the hardness of the surface layer being measured at about 80 HRB to about 85 HRB.

### Example 5

A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

Several test pieces were prepared from a forged Cr—Mo—V—Nb—B alloy steel (9.0-9.6% Cr, 1.50-1.70% Mo, 0.25-0.30% V, 0.045-0.065% Nb, 0.008-0.012% B). The test pieces each had an approximate size of 25.4×25.4×12.7 mm (1×1×0.5 inches). A slurry coating of non-uniform thickness was applied directly to the surface of each of the test pieces. The coating was applied by pouring the slurry mixture over the test pieces and spreading the mixture around the entire surface of each test piece.

The test pieces were placed in a retort, which was then purged with argon until a −40° F. dew point was achieved. The temperature within the retort was then heated to a diffusion temperature of 2000° F. and held at such temperature for a duration of 4 hours. The argon gas flow was maintained during heating. The retort was then cooled under argon gas.

The test pieces were then removed from the retort chamber and subjected to oxidation testing. The test pieces were placed in a controlled, oxidizing environment at 1800° F. for 5000 hours. The test pieces were then examined and no signs of oxidation were found. Typically, the alloy steel tested would rapidly oxidize at temperatures above about 1000° F.

### Example 6

A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

Several test pieces were prepared from a cast 410 stainless steel (12% Cr). The test pieces each had an approximate size of 25.4×25.4×12.7 mm (1×1×0.5 inches). A slurry coating of non-uniform thickness was applied directly to the as-cast surfaces of each test piece. The coating was applied by pouring the slurry mixture over the test pieces and spreading the mixture around the entire surface of each test piece.

The test pieces were placed in a retort, which was then purged with argon until a −40° F. dew point was achieved. The temperature within the retort was then heated to a diffusion temperature of 2000° F. and held at such temperature for a duration of 4 hours. The argon gas flow was maintained during heating. The retort was then cooled under argon gas.

The test pieces were then removed from the retort chamber and subjected to oxidation testing. The test pieces were placed in a controlled, oxidizing environment at 1800° F. for 5000 hours. The test pieces were then examined and no signs of oxidation were found. Typically, the alloy steel tested would rapidly oxidize at temperature above about 1200° F.

### Example 7

As a comparative example and to provide an indication of the effect of nickel within a base metal, a nickel-containing test piece was also tested. A slurry coating composition was prepared having the following slurry composition, by weight: 50% chromium aluminum (56Cr-44Al), 10% ammonium chloride, the balance being VITTA BRAZ-BINDER GEL. The chromium aluminum was in powder form having a particle size of −200 mesh.

A test piece was prepared from an austenitic 347 stainless steel (21% Cr12% Ni). The test piece had an approximate size of 25.4×25.4×12.7 mm (1×1×0.5 inches). A slurry coating of non-uniform thickness was applied directly to the surface of the test piece. The coating was applied by pouring the slurry mixture over the test piece and spreading the mixture around the entire surface of the test piece.

The test piece was placed in a retort, which was then purged with argon until a −40° F. dew point was achieved. The temperature within the retort was then heated to a diffusion temperature 2000° F. and held at such temperature for a duration of 4 hours. The argon gas flow was maintained during the heating. The retort was then cooled under argon gas and the test piece was removed from the retort and sectioned to permit its diffusion coating/zone to be measured.

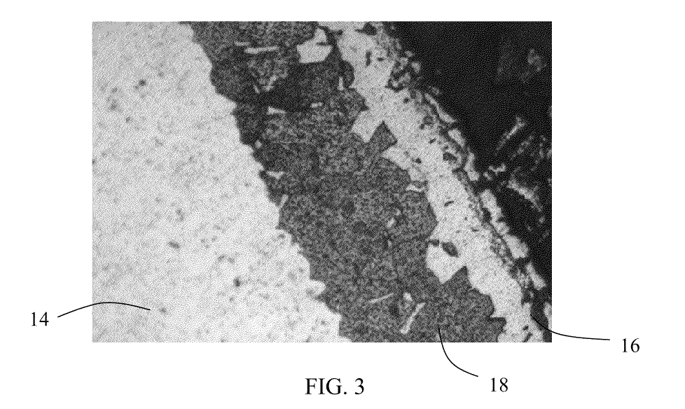

FIG. 3 is a micrograph of the 347 stainless test piece following the diffusion treatment. As can be seen, a diffusion coating/zone 16,18 was formed having two separate layers. The outer layer 16 consisted of an aluminum-nickel phase diffusion coating, with a thickness of approximately 25 micrometers. The hardness of this outer coating 16 was approximately 30 HRB. The inner layer 18 consisted of a hard, nickel-depleted diffusion zone having a thickness of approximately 75 micrometers. The hardness of this brittle diffusion zone was approximately 35 HRC. The hardness of the non-diffused base metal 14 was measured at approximately 80 HRB.

Examples 1-6 illustrate that a relatively thick and ductile aluminum diffusion surface layer may be created in a turbine component formed from a base metal being substantially free from nickel and cobalt. Such surface layer may prevent oxidation of the turbine component by forming a protective alumina scale in the presence of high temperature oxidants. As such, the present subject matter provides for the creation of oxidation resistant turbine components that may be produced using low grade/alloy steels at a fraction of the cost generally associated with the use of specialty alloys.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for creating an aluminum diffusion surface layer within a substantially nickel- and cobalt-free component, the method comprising:
applying a slurry coating to a surface of a component, said slurry coating being free from inert fillers and comprising a metallic aluminum alloy, a halogen activator, and a binder; and
heating said component to diffuse aluminum from said slurry coating into said component to form an aluminum diffusion surface layer within said component, said aluminum diffusion surface layer characterized by an intermetallic aluminum-containing phase, wherein said component is formed from a base metal being substantially free from both nickel and cobalt and comprising up to about 27% chromium by weight.

2. The method of claim 1, wherein said component is heated to a diffusion temperature of about 1500° F. to about 2100° F. for about 2 hours to about 12 hours.

3. The method of claim 1, wherein said aluminum diffusion surface layer has a thickness of about 25 micrometers to about 400 micrometers.

4. The method of claim 1, wherein said aluminum diffusion surface layer has a thickness of about 200 micrometers to about 350 micrometers.

5. The method of claim 1, wherein said base metal comprises between about 8% to about 11% chromium by weight.

6. The method of claim 1, wherein said base metal comprises between about 11% to about 27% chromium by weight.

7. The method of claim 1, wherein said base metal comprises between about 1% to about 8% chromium by weight.

8. The method of claim 1, wherein said base metal comprises less than 1% chromium by weight.

9. The method of claim 1, wherein said aluminum diffusion surface layer has a hardness value of about 75 HRB to about 90 HRB.

10. The method of claim 1, wherein said component comprises a cast turbine component, said slurry coating being applied to an as-cast surface of said cast turbine component.

11. The method of claim 1, wherein said component comprises a wrought turbine component.

12. An oxidation resistant component, the oxidation resistant component comprising:
a base metal configured as a component, said base metal being substantially free from nickel and cobalt and comprising up to about 27% chromium by weight; and
an aluminum diffusion surface layer extending below a surface of said base metal, said aluminum diffusion surface layer characterized by an intermetallic aluminum-containing phase having a thickness of greater than about 50 micrometers.

13. The oxidation resistant component of claim 12, wherein said aluminum diffusion surface layer has a thickness of about 50 micrometers to about 400 micrometers.

14. The oxidation resistant component of claim 12, wherein said aluminum diffusion surface layer has a thickness of about 200 micrometers to about 350 micrometers.

15. The oxidation resistant component of claim 12, wherein said base metal comprises between about 8% to about 11% chromium by weight.

16. The oxidation resistant component of claim 12, wherein said base metal comprises between about 11% to about 27% chromium by weight.

17. The oxidation resistant component of claim 12, wherein said base metal comprises between about 1% to about 8% chromium by weight.

18. The oxidation resistant component of claim 12, wherein said base metal comprises less than about 1% chromium by weight.

19. The oxidation resistant component of claim 12, wherein said component comprises a cast turbine component or a wrought turbine component.

20. The oxidation resistant component of claim 12, wherein said aluminum diffusion surface layer has a hardness value of about 75 HRB to about 90 HRB.
